(19) United States
(12) Patent Application Publication
(10) Pub. No.: US 2026/0270681 A1
(43) Pub. Date: Sep. 10, 2026

(54) Capability Design for SSB-Less Carrier Aggregation Operation

(71) Applicant: Apple Inc., CUPERTINO, CA (US)

(72) Inventors: Jie CUI, San Jose, CA (US); Dawei ZHANG, Saratoga, CA (US); Hong HE, San Jose, CA (US); Konstantinos SARRIGEORGIDIS, Los Gatos, CA (US); Manasa RAGHAVAN, Sunnyvale, CA (US); Qiming LI, Beijing (CN); Yang TANG, San Jose, CA (US)

(21) Appl. No.: 18/861,678

(22) PCT Filed: Nov. 2, 2023
(86) PCT No.: PCT/CN2023/129373

§ 371 Date: Oct. 30, 2024

(51) Int. Cl. H04W 8/24

(52) U.S. Cl. CPC H04W 8/24

(57) ABSTRACT

A user equipment (UE) configured to determine one or more band combinations that support a SSB-less carrier aggregation (CA) operation, wherein, for the SSB-less carrier aggregation (CA) operation, the UE is configured to receive a first component carrier (CC) having a Synchronization Signal Block (SSB) of a CA combination from a first serving cell and receive a second CC without SSBs of the CA combination a second serving cell and transmit, to a network, capability information comprising an indication of the one or more band combinations that support the SSB-less CA operation.

### TECHNICAL FIELD

This application relates generally to wireless communication systems, and in particular relates to capability design for SSB-less carrier aggregation operation.

### BACKGROUND

A Synchronization Signal Block (SSB) is a reference (RS) transmitted by a base station and used by a user equipment (UE) for time and frequency synchronization with the cell. Thus, muting of such an RS may result in the UE not being synchronized with the cell. However, when a UE and the network are communicating using carrier aggregation (CA) there may be circumstances, e.g., power saving, where it would be beneficial if a secondary cell (SCell) could mute SSB transmissions without a UE becoming out of synchronization with the SCell. When one or more SCells have muted SSB transmissions during CA operations, this may be referred to as SSB-less CA.

### SUMMARY

Some example embodiments are related to an apparatus of a user equipment (UE), the apparatus including processing circuitry configured to determine one or more band combinations that support a SSB-less carrier aggregation (CA) operation, wherein, for the SSB-less carrier aggregation (CA) operation, the UE is configured to receive a first component carrier (CC) having a Synchronization Signal Block (SSB) of a CA combination from a first serving cell and receive a second CC without SSBs of the CA combination a second serving cell and configure transceiver circuitry to transmit, to a network, capability information comprising an indication of the one or more band combinations that support the SSB-less CA operation.

Other example embodiments are related to an apparatus of a base station, the apparatus including processing circuitry configured to determine reference information comprising a reference component carrier (CC), a band of a reference CC, a reference Synchronization Signal Block (SSB) frequency or a reference SSB for a SSB-less carrier aggregation (CA) operation for a user equipment (UE) and decode, based on signals received from the UE, capability information comprising an indication of one or more band combinations that support the SSB-less CA operation.

Still further example embodiments are related to an apparatus of a base station, the apparatus including processing circuitry configured to decode, based on signals received from a user equipment (UE), reference information comprising a reference component carrier (CC), a band of a reference CC, a reference Synchronization Signal Block (SSB) frequency or a reference SSB for a SSB-less carrier aggregation (CA) operation for the UE and decode, based on signals received from the UE, capability information comprising an indication of one or more band combinations that support the SSB-less CA operation.

Additional example embodiments are related to an apparatus of a base station, the apparatus including processing circuitry configured to decode, based on signals received from a user equipment (UE), capability information comprising an indication of one or more band combinations that support a Synchronization Signal Block (SSB)-less (SSB-less) carrier aggregation (CA) operation, wherein, during the SSB-less CA operation, a first serving cell transmits a first component carrier (CC) having a SSB of a CA combination and a second serving cell transmits a second CC without SSBs of the CA combination, wherein the capability information further comprises a frequency domain (FD) separation threshold indicating a value in the FD from a CC with SSB that the UE supports the SSB-less CA operation and determine, based on the capability information, CC combinations within the one or more band combinations that support the SSB-less CA operation.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example two band combination for SSB-less CA operation according to various example embodiments.

FIG. 5 shows an example three band combination for SSB-less CA operation according to various example embodiments.

FIGS. 6A and 6B show example three band combinations where the UE may report a frequency domain (FD) separation threshold when reporting UE capabilities for SSB-less CA operations according to various example embodiments.

FIG. 7 shows an example method of UE operations for SSB-less CA operation according to various example embodiments.

FIG. 8 shows an example method of base station operations for SSB-less CA operation according to various example embodiments.

### DETAILED DESCRIPTION

The example embodiments may be further understood with reference to the following description and the related appended drawings, wherein like elements are provided with the same reference numerals. The example embodiments relate to one or more secondary cells (SCells) of a carrier aggregation (CA) combination muting Synchronization Signal Blocks (SSBs) when transmitting to a UE. More specifically, the example embodiments relate to a UE reporting capability information for SSB-less CA operations on a per-band basis to the network and the network using this capability information to configure SSB-less CA operations for the UE.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. The example embodiments may also be implemented in other types of networks, including but not limited to LTE networks, future evolutions of the cellular protocol (e.g., 5G-Advanced networks, 6G networks), or any other type of network.

The example embodiments are also described with reference to carrier aggregation (CA). In CA, a UE may communicate in the downlink (DL) or uplink (UL) with multiple cells of a network to increase throughput. CA includes the UE associating with a Primary Cell (PCell) and one or more Secondary Cells (SCells). Different band combinations of CA may be served by the PCell and SCell, e.g., the PCell may serve a first component carrier (CC) of a CA band combination (e.g., CC1) to the UE and the SCell may serve a second CC of the CA band combination (e.g., CC2) to the UE. Thus, in CA, both the PCell and the SCell are considered to be serving cells.

The example embodiments provide manners for a UE to report UE capability information for SSB-less CA operation on a per-band basis. The example embodiments provide the UE and the network with enough information on the reported band combinations that both the UE and the network understand the component carrier (CC) combinations within the reported band combinations for which the UE supports SSB-less CA operation.

Each of these example embodiments will be described in greater detail below.

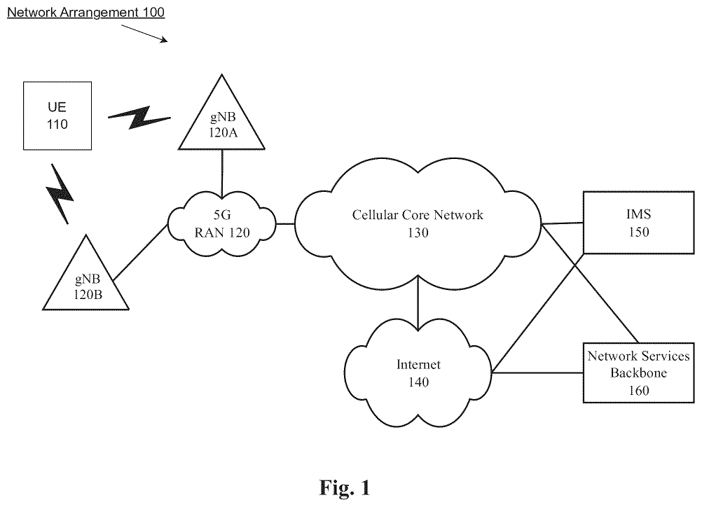

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, embedded devices, wearables, Internet of Things (IOT) devices, etc. An actual network arrangement may include any number of UEs being used by any number of users.

Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120.

Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and the gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a subscriber identity module (SIM) card or an embedded SIM (eSIM). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

In this example, it may be considered that the UE 110 is operating in CA mode where the gNB 120A is the PCell and the gNB 120B is the SCell that will be operating in SSB-less mode.

As described above, CA mode may include multiple SCells but for the purpose of description only a single SCell is shown. In the example embodiments, it may be considered that the PCell and SCell are co-located, e.g., in the same general physical location (e.g., on the same cell tower). However, there is no requirement that the PCell and SCell be co-located. Also, while the PCell and SCell are shown as being different gNBs, a single gNB may include multiple cells. Thus, the PCell and SCell may be cells of the same gNB.

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

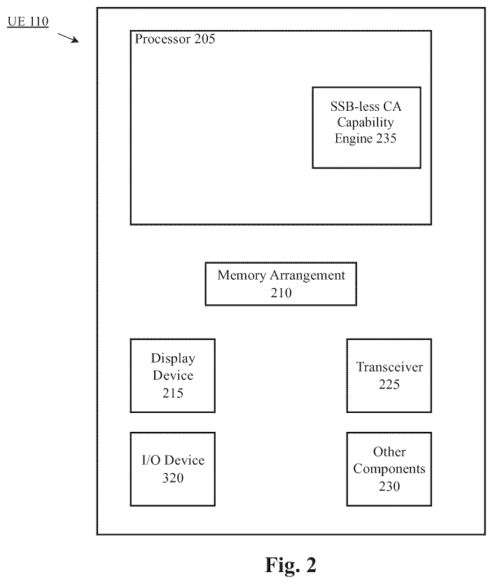

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an SSB-less CA Capability Engine 235 for performing operations related to SSB-less CA operation. The operations include, but are not limited to, determining reference information related to SCells for SSB-less CA operations, determining band combinations and or CC combinations for which the UE supports SSB-less CA operation and reporting SSB-less CA capability information on a per-band basis to the network. Each of these example operations and other operations will be described in more detail below.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e. g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

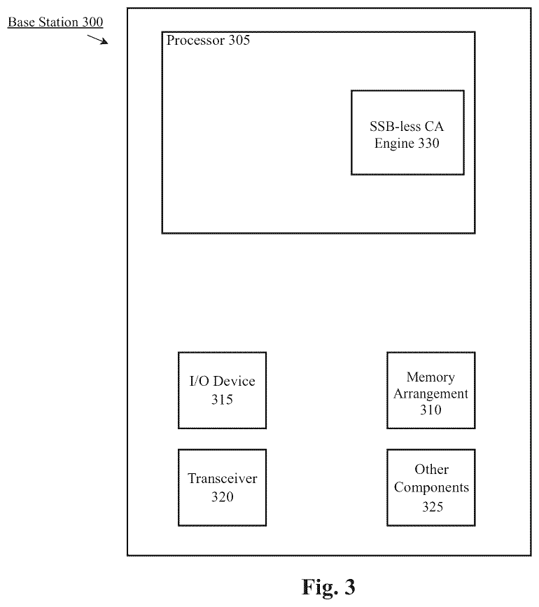

FIG. 3 shows an example base station 300 according to various example embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include an SSB-less CA engine 330 for performing operations related to configuring a UE for SSB-less CA operations. The operations include, but are not limited to, determining reference information related to SCells for SSB-less CA operations for the UE, receiving SSB-less CA capability information on a per-band basis from the UE and determining CC combinations within the band combinations for which the UE supports SSB-less CA operation. Each of these example operations and other operations will be described in more detail below.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

Prior to describing the example embodiments, a general overview of operations where an SCell is operating with muted SSBs, e.g., SSB-less operation, is described. SSBs are used by the UE to remain in time and frequency synchronization including downlink automatic gain control (AGC) with a cell. Thus, by muting the SSB, the SCell may be risking the UE becoming out of synchronization with the SCell.

When the SCell is operating in SSB-less mode, the UE 110 may reuse synchronization information from a serving cell serving a CC of a CA band combination. Specifically, in the examples provided, it will be considered that the PCell 120A is serving the CC1 and the SCell 120B is serving the CC2 of the CA band combination CC1+CC2. Thus, in the examples, it will be considered that the SCell 120B is operating in SSB-less mode and when referring to the UE 110 reusing the synchronization information from the serving cell, the serving cell is the PCell 120A.

The PCell being the inter-band serving cell is only an example. As described above, when operating in CA, the PCell and the one or more SCells are considered serving cells. For example, consider a 3 CC band combination where the PCell serves CC1, an SCell 1 serves CC2 and an SCell 2 serves CC3. When the SCell 1 operates in SSB-less mode, the UE may reuse synchronization information from either the PCell or the SCell 2 (e.g., reference to the inter-band serving cell may be a reference to either the PCell or the SCell 2). Thus, while the example embodiments describe the PCell as the serving cell, the serving cell is not required to be a PCell.

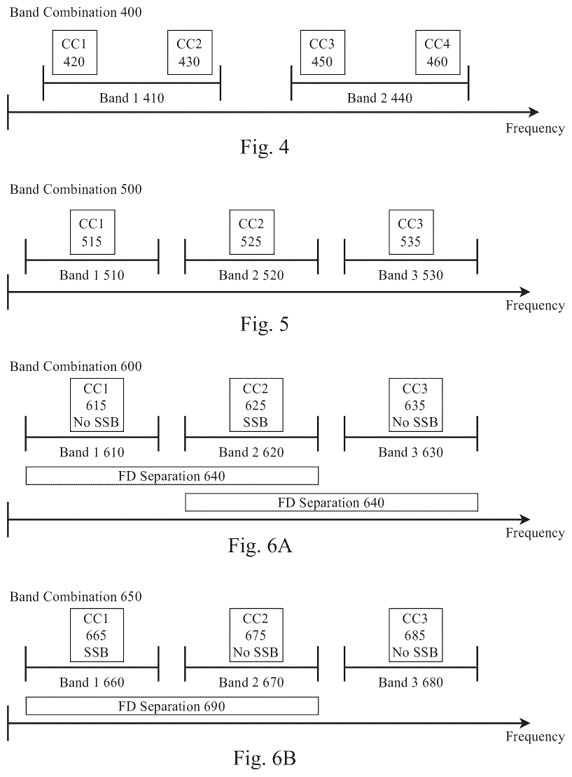

As stated above, the UE 110 may report a capability of supporting a SSB-less CA operation. In some example embodiments, this UE capability may be reported on a per-band combination. For example, the UE 110 may report the bands on which the UE 110 can support SSB-less CA operation. The reporting of this capability on a per-band basis may have certain advantages such as a reduction in signaling overhead compared to UE capability reporting on a more granular basis, e.g., per CC combination. However, certain issues may arise when reporting the UE capabilities for SSB-less CA operation on a per-band basis. Some example issues that may arise are described with reference to FIGS. 4 and 5.

FIG. 4 shows an example two band combination 400 for SSB-less CA operation according to various example embodiments. In this example, it may be considered that the band combination is Band 1 410+Band 2 440. Each of the bands may have a large frequency range, e.g., up to 1 GHz. Within this band combination, there may be one or more CC combinations that are CA CC combinations. In this example, it may be considered that the Band 1 410+Band 2 440 band combination includes the following CC combinations CC1 420+CC4 460 and CC2 430+CC3 450.

Thus, when the UE 110 is determining whether it supports SSB-less CA operations on a per-band basis, the UE 110 may determine the different CC combinations that are supported by the band combination. In this example, the UE 110 may determine that the frequency domain (FD) separation between the CC2 420+CC3 450 is sufficiently small that the UE 110 can Support SSB-less SCell operations for this CC combination. On the other hand, the UE 110 may determine that the FD separation between the CC1 420+CC4 460 is too large to support SSB-less CA operations for this CC combination. In this scenario, the UE 110 may report that it does not support SSB-less CA operations for the Band 1410 +Band 2 440 band combination because there is one or more CC combinations where SSB-less CA operations are not supported, e.g., CC1 420+CC4 460. Thus, even though there are one or more CC combinations, e.g., CC2 420+CC3 450, within the Band 1410 +Band 2 440 band combination that are supported, the UE 110 will report that it does not support SSB-less CA operations for the entire Band 1410 +Band 2 440 band combination.

FIG. 5 shows an example three band combination for SSB-less CA operation according to various example embodiments. In this example, it may be considered that the band combination is Band 1510 +Band 2 520 +Band 3 530. Within this band combination, there may be one or more CC combinations that are CA CC combinations. In this example, it may be considered that the band combination 500 includes the following CC combination CC1 515+CC2 525+CC3 535.

In a first example of the band combination 500, it may be considered that for the CC combination CC1 515+CC2 525+CC3 535, the CC2 525 is the reference CC, e.g., the serving cell serving CC2 is transmitting SSBs, while the CC1 515 and CC3 535 are transmitted by SSB-less SCells. In this example, the UE 110 may determine that the FD separation between the CC2 525 and CC1 515 and between CC2 and CC3 535 is sufficiently small that the UE 110 can support SSB-less CA operations for this CC combination. However, in a second example of the band combination 500, it may be considered that for the CC combination CC1 515+CC2 525+CC3 535, the CC1 515 is the reference CC, e. g., the serving cell serving CC1 is transmitting SSBs, while the CC2 525 and CC3 535 are transmitted by SSB-less SCells. In this example, the UE 110 may determine that the FD Separation between the CC1 515 and CC2 525 is sufficiently small that the UE 110 can support SSB-less CA operations for these CCs, but the FD separation between the CC1 515 and CC3 535 is too large to support SSB-less CA operations. Thus, the UE 110 may again report that the UE 110 does not support the band combination 500 because there are CC combinations and/or reference CCs within the CC combinations that do not support SSB-less CA operations.

The example embodiments provide a UE capability reporting design on a per-band basis for support of SSB-less CA operations that may resolve the above example issues and other issues. The example embodiments may consider both the signaling overhead and indication accuracy associated with the UE capability reporting. These example embodiments will be described in greater detail below.

In some example embodiments, one CC or band may be used as a reference CC, and the UE capability reporting on the per-band basis may then be based on using this CC as the reference CC. The CC that is the reference CC may be defined by the UE 110, by the network or may be predefined in standards documents (e.g., 3GPP Technical Specifications TS 38.331, 38.306).

the network may indicate to the UE 110 a reference CC, a reference band, a reference SSB frequency or a reference SSB. This indication may be provided to the UE 110 by a base station, for example, the PCell, e.g., the gNB 120A, before or during the SSB-less CA configuration. The SSB-less CA configuration may be performed using Radio Resource Control (RRC) signaling and thus, the reference indication may also be provided via RRC signaling. However, in some example embodiments, the reference indication (e.g., reference CC, reference band, reference SSB frequency or reference SSB) may be provided via other types of signaling such as Medium Access Control Control Element (MAC-CE) signaling, Downlink Control Information (DCI) signaling, etc.

The UE 110 receives this reference information (e.g., reference CC, reference band, reference SSB frequency or reference SSB) and may then determine which bands may be used for SSB-less CA operation and the UE 110 may then report this capability to the network. Referring to FIG. 5 to provide an example, the reference information may have indicated that CC2 525, Band 2 520, the SSB frequency associated with CC2 525 or the SSB associated with CC2 525 is the reference. Thus, the UE 110 understands that in the example of FIG. 5, CC2 525 is the reference CC for the CC combination CC1 515+CC2 525+CC3 535. In this example, the UE 110 supports SSB-less CA operations for this combination when the CC2 525 is the reference CC. Thus, in this example, when reporting the UE capability, the UE 110 may report that the UE supports SSB-less CA operations for band combination 500, e.g., Band 1510+Band 2 520+Band 3 530, because the UE 110 understands that the CC2 525 is the reference CC.

To provide another example, the UE 110 may support five (5) bands, e.g., band 1/2/3/4/5. The UE 110 may receive reference information indicating that a CC1 of band 1 or band 1 is the reference CC or band for SSB-less CA operation. The UE 110 may use this information to determine which supported bands can be used for SSB-less CA operation. For example, based on this information, the UE 110 may determine that bands 2 and 3 may be used for SSB-less CA operation with band 1 as a reference band. Thus, the UE 110 may report the UE capability for SSB-less CA operation on a per-band basis as, for example, Band 1+Band 2, Band 1+Band 3 and Band 1+Band 2+Band 3.

In a second example of the UE using reference information, the network may or may not request the UE 110 to report the capability of SSB-less CA operation. For example, the network may explicitly request the UE 110 to provide UE capability information related to SSB-less CA operation. On the other hand, the UE 110 may provide UE capability information related to SSB-less CA operation without an explicit request from the network, e.g., upon connecting to the network.

In this example, the UE 110 may select and/or indicate the band, the CC, the SSB frequency or the SSB that is the reference. Based on the indicated reference information, the UE 110 may then report the UE capability information on a per-band basis for SSB-less CA operation. The examples provided above for the network supplied reference information would also apply to this UE selected/indicated reference information provided that the UE 110 selected/indicated the same reference information as described in the examples.

In these example embodiments, the UE 110 may indicate multiple combinations based on the selection of different reference information. To provide an example, consider the example provided above where the UE 110 may support five (5) bands, e.g., band 1/2/3/4/5. The UE 110 may indicate reference information indicating that a CC1 of band 1 or band 1 is the reference CC or band for SSB-less CA operation. As described above, when the CC1 of Band 1or Band 1is the reference information, the UE 110 may report the UE capability for SSB-less CA operation on a per-band basis as, for example, Band 1+Band 2, Band 1+Band 3 and Band 1+Band 2+Band 3. On the other hand, the UE 110 may also indicate that a CC3 of Band 3 or band 3 is the reference CC or band for SSB-less CA operation. In this scenario, the UE 110 may determine that Bands 2 and 5 may be used for SSB-less CA operation with Band 3 as a reference band. Thus, the UE 110 may report the UE capability for SSB-less CA operation on a per-band basis as, for example, Band 3+Band 2, Band 3+Band 5 and Band 3+Band 2+Band 5. In this example, the UE 110 may report both capabilities, e.g., with Band 1as the reference band and with Band 3 as the reference band.

In a third example of the UE using reference information, the reference information may be based on predefined rules that are, for example, provided by standards such as the 3GPP Technical Specifications (e.g., TS 38.331, 38.306). These predefined rules may indicate to the UE and the network which cell, CC or band is the reference band for purposes of reporting the UE capability with respect to the SSB-less CA operation.

A first example rule may be that the Primary Component Carrier (PCC) or PCC band is the reference CC or band. A second example rule may be that the Primary Secondary Component Carrier (PSCC) or PSCC band is the reference CC or band. When the UE is capable of EUTRA NR Dual Connectivity (ENDC) operation, the PSCC is may be the strongest NR cell.

A third example rule may be that an activated Secondary Component Carrier (SCC) that is transmitted with SSBs and has the highest signal strength/quality among activated SCCs or its band is the reference CC or band. A fourth example rule may be that an activated closest SCC with SSB on the frequency domain is the reference CC or band. For example, if there is only one activated SCC with SSB, then that SCC is by definition the closest SCC with SSB on the frequency domain. On the other hand, if there are multiple activated SCC with SSB, the UE 110 may select the SCC that is closest in the frequency domain to the target SCC as the reference CC or band. For example, the network may provide the center frequency of each SCC (e. g., activated, target) and the UE may use this information for Selection of the closest activated SCC with SSB in the frequency domain.

The above described rules are only examples and other rules to select a reference CC or band may also be defined. In addition, the rules may be applied individually or in combination (e. g., in hierarchical manner) when being used to select a reference CC or band.

The UE 110 may apply these rules to determine the reference CC or band and then determine the per-band combinations that support SSB-less CA operations. The UE 110 may then indicate the UE capability with respect to the SSB-less operations on a per-band basis to the network.

To continue with the example provided above where the UE 110 may support five (5) bands, e.g., band 1/2/3/4/5. The UE 110 may determine, based on the predefined rules, that a CC1 of Band 1or Band 1is the reference CC or band for SSB-less CA operation, e. g., the CC1 or the Band 1is the PCC or the PCC band. The UE 110 may use this information to determine which supported bands can be used for SSB-less CA operation. For example, based on this information, the UE 110 may determine that Bands 2 and 3 may be used for SSB-less CA operation with Band 1as a reference band. Thus, the UE 110 may report the UE capability for SSB-less CA operation on a per-band basis as, for example, Band 1+Band 2, Band 1+Band 3 and Band 1+Band 2+Band 3.

In an example scenario where there is only one serving CC for the UE 110 that has SSB, e. g., only one CC is transmitted with SSBs, the UE 110 may select this CC or band as the reference CC because it is the only CC that has SSBs. In this scenario, if the example of the network providing the reference information is implemented, the network may not have to provide any signaling to the UE 110 because the UE 110 will implicitly understand that there is only a single possibility for the reference CC or band. Similarly, if the UE 110 is selecting and indicating the reference information, the UE 110 may not have to provide any signaling to the network because both the UE 110 and the network will implicitly understand that there is only a single possibility for the reference CC or band. This implies that the third example of the UE using reference information is applied in this scenario.

In an example scenario where there are multiple serving CCs for the UE 110 that have SSB, signaling solutions of the first or second examples of the UE using reference information may be used. In one case of this example scenario, the network may provide the reference information as described in the first example above. In another case of this example scenario, the UE 110 may signal the network with the reference information as described in the second example above.

In other example embodiments, the UE 110 may report the largest band or CC combination set to the network together with a frequency domain (FD) separation. The largest band or CC combination set means the UE 110 supports SSB-less CA operation with at least a subset or a full set of this band/CC combination. For example, referring to FIGS. 4 and 5, if it were considered that the UE 110 supported at least a subset of CC combinations for band combination 400 and band combination 500, the UE 110 may report the band combination 500 because it represents largest band or CC combination set, e.g., 3 bands as opposed to 2 bands of band combination 400.

FIGS. 6A and 6B show example three band combinations 600 and 650 where the UE may report a FD separation threshold when reporting UE capabilities for SSB-less CA operations according to various example embodiments. FIGS. 6A and 6B are similar to FIG. 5. In the example of FIG. 6A, it may be considered that the band combination is Band 1610+Band 2620+Band 3 630. Within this band combination, there may be one or more CC combinations that are CA CC combinations. In this example, it may be considered that the band combination 600 includes the following CC combination CC1 615+CC2 625+CC3 635. In this example, it is also shown that CC1 615 and CC3 635 are transmitted as SSB-less while the CC2 625 is transmitted with SSBs.

As described above, in these example embodiments, it may be considered that the UE 110 has identified the band combination 600 as the largest band or CC combination set and therefore, this band combination 600 may be reported to the network by the UE 110. As described above, in these example embodiments, the UE 110 will also report an FD separation threshold, e.g., FD separation 640. The FD separation threshold indicates to the network a separation in the FD for which the UE will support SSB-less CA operations. For example, if a CC that does not include SSBs is within the FD separation threshold from a CC on which SSBs are transmitted, the UE will support SSB-less CA operation for these CCs. If a CC that does not include SSBs is outside the FD separation threshold from a CC on which SSBs are transmitted, the UE will not support SSB-less CA operation for these CCs. Thus, in these example embodiments, the network will understand which CC combinations are supported by the UE 110 based on the reported per-band SSB-less CA operation combination and the FD separation.

Referring to FIG. 6A, the UE 110 reports the band combination 600, e.g., the largest band or CC combination set, along with the FD separation threshold 640 to the network. The network may use this information to understand the different CC combinations within the band combination 600 that is supported by the UE. As shown in FIG. 6A, the CC2 625 is transmitted with SSBs. The CC1 615 that is transmitted without SSBs is within the FD separation threshold 640 from the CC2 625 and therefore, the network understands that the UE 110 supports the CA combination of CC2 625+CC1 615. In addition, the CC3 635 that is transmitted without SSBs is also within the FD separation threshold 640 from the CC2 625 and therefore, the network understands that the UE 110 also supports the CA combination of CC2 625+CC3 635. Further, this also implies that the UE 110 would support the CA combination of CC1 615+CC2 625+CC3 635.

In the example of FIG. 6B, it may be considered that the band combination is Band 1660+Band 2 670+Band 3 680.

Within this band combination, there may be one or more CC combinations that are CA CC combinations. In this example, it may be considered that the band combination 650 includes the following CC combination CC1 665+CC2 675+CC3 685. In this example, it is also shown that CC2 675 and CC3 685 are transmitted as SSB-less while the CC1 665 is transmitted with SSBS.

Similar to FIG. 6A, in the example of FIG. 6B, the UE 110 reports the band combination 650, e.g., the largest band or CC combination set, along with the FD separation threshold 690 to the network. The network may use this information to understand the different CC combinations within the band combination 600 that is supported by the UE. As shown in FIG. 6A, the CC1 665 is transmitted with SSBs. The CC2 675 that is transmitted without SSBs is within the FD separation threshold 690 from the CC1 665 and therefore, the network understands that the UE 110 supports the CA combination of CC1 665+CC2 675. In contrast, the CC3 685 that is transmitted without SSBs is outside the FD separation threshold 690 from the CC1 665 and therefore, the network understands that the UE 110 does not support any CA combinations including the CC1 665 and the CC3 685.

As can be seen from the above examples, the use of the FD separation threshold allows the UE 110 to report band combinations as SSB-less CA operation supported combinations even when some of the CC combinations within the band combinations are not supported. In the example of FIG. 6B, the UE 110 may report the band combination 650 as a SSB-less CA operation supported band combination even though the specific CC combination of CC1 665+CC3 685 is not supported. This is because the network using the CA capability information provided by the UE 110 and the understanding of which CCs are transmitted with and without SSBs may determine the CC combinations within the band combination 650 that support SSB-less CA operation.

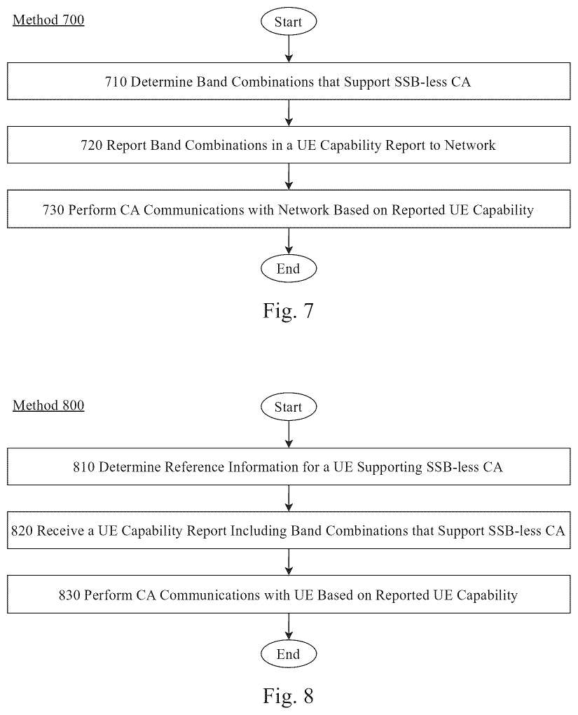

FIG. 7 shows an example method 700 of UE 110 operations for SSB-less CA operation according to various example embodiments. In 710, the UE 110 may determine on a per-band basis, one or more band combinations for which the UE 110 supports SSB-less CA operation. As described above, in some example embodiments, this determination is made based on reference information, e.g., a reference CC, a band of a reference CC, a reference SSB frequency or a reference SSB.

In some examples, the reference information may be provided to the UE 110 by the network, e.g., by the base station 300, a component of the core network 130, etc. In other examples, the reference information may be selected by the UE 110 and reported to the network. In further examples, the UE and the network may determine the reference information based on one or more predefined rules, e.g., as encoded in standards documents such as the 3GPP Technical Specifications.

In 720, the UE 110 reports the one or more band combinations to the network using a UE capability information report for SSB-less CA operation. In some example embodiments, the UE 110 may include an FD separation threshold value with the UE capability information. The FD separation threshold value indicates to the network a separation in the FD from a CC that includes SSBs within which the UE 110 supports SSB-less CA operation, e.g., supports CA with a CC that does not include SSBs.

In 730, assuming that the UE 110 has provided a UE capability information report that includes at least one supported band combination, the UE 110 and the network may communicate using SSB-less CA operations when the network configures the UE 110 to operate in such a manner.

FIG. 8 shows an example method 800 of base station 300 operations for SSB-less CA operation according to various example embodiments. In 810, the base station 300 may determine reference information, e. g., a reference CC, a band of a reference CC, a reference SSB frequency or a reference SSB, for the UE 110 for SSB-less CA operations.

In some examples, the reference information may be determined by the base station 300 and provided to the UE 110, e.g., via RRC signaling. In other examples, the reference information may be selected by the UE 110 and reported to the base station 300. In further examples, the base station 300 and the UE 110 may determine the reference information based on one or more predefined rules, e.g., as encoded in standards documents such as the 3GPP Technical Specifications.

In 820, the base station 300 receives a UE capability information report from the UE 110 including one or more band combinations for which the UE 110 supports SSB-less CA operation. In some example embodiments, the UE 110 may include an FD separation threshold value with the UE capability information. The FD separation threshold value indicates to the base station 300 a separation in the FD from a CC that includes SSBs within which the UE 110 supports SSB-less CA operation, e.g., supports CA with a CC that does not include SSBs. The base station may use the reference information and/or the UE capability information to determine the CC combinations within the one or more band combinations for which the UE 110 supports SSB-less CA operation.

In 830, assuming that the UE 110 has provided a UE capability information report that includes at least one supported band combination, the base station 300 and the UE 110 may communicate using SSB-less CA operations when the base station 300 configures the UE 110 to operate in such a manner.

### EXAMPLES

In a first example, a method performed by a user equipment (UE), comprising determining one or more band combinations that support a SSB-less carrier aggregation (CA) operation, wherein, for the SSB-less carrier aggregation (CA) operation, the UE is configured to receive a first component carrier (CC) having a Synchronization Signal Block (SSB) of a CA combination from a first serving cell and receive a second CC without SSBs of the CA combination a second serving cell and transmitting, to a network, capability information comprising an indication of the one or more band combinations that support the SSB-less CA operation.
In a second example, the method of the first example, wherein the one or more band combinations that support the SSB-less CA operation is determined based on reference information comprising a reference CC, a band of a reference CC, a reference SSB frequency or a reference SSB.
In a third example, the method of the second example, further comprising decoding, based on signals received from the network, the reference information.
In a fourth example, the method of the third example, wherein the reference information is received from the network before or during SSB-less CA configuration.
In a fifth example, the method of the third example, wherein the reference information is received via radio resource control (RRC) signaling.
In a sixth example, the method of the second example, further comprising determining the reference information and transmitting the reference information to the network.
In a seventh example, the method of the sixth example, wherein the reference information comprises a first reference information used to determine a first band combination that supports the SSB-less CA operation and a second reference information used to determine a second band combination that supports the SSB-less CA operation, wherein the first band combination and the second band combination are different band combinations.
In an eighth example, the method of the second example, further comprising determining the reference information based on a predefined rule.
In a ninth example, the method of the eighth example, wherein the predefined rule comprises determining the reference information based on (i) a Primary CC (PCC), (ii) a band of the PCC, (iii) a Primary Secondary CC (PSCC), (iv) a band of the PSCC, (v) an activated Secondary CC (SCC) with SSB having a highest signal strength or quality among SCCs, (vi) a band of the activated SCC with SSB having the highest signal strength or quality among SCCs or (vii) an activated SCC with SSB having a frequency closest to a frequency of a target SCC.
In a tenth example, the method of the first example, wherein the capability information further comprises a frequency domain (FD) separation threshold indicating a value in the FD from a CC with SSB that the UE supports the SSB-less CA operation.
In an eleventh example, the method of the tenth example, wherein the capability information comprises the one or more band combinations that support the SSB-less CA operation for a largest band or CC combination set.
In a twelfth example, a processor configured to perform any of the methods of the first through eleventh examples.
In a thirteenth example, a user equipment (UE) comprising a transceiver configured to communicate with a network and a processor communicatively coupled to the transceiver and configured to perform any of the methods of the first through eleventh examples.
In a fourteenth example, a method performed by a base station, comprising determining reference information comprising a reference component carrier (CC), a band of a reference CC, a reference Synchronization Signal Block (SSB) frequency or a reference SSB for a SSB-less carrier aggregation (CA) operation for a user equipment (UE) and decoding, based on signals received from the UE, capability information comprising an indication of one or more band combinations that support the SSB-less CA operation.
In a fifteenth example, the method of the fourteenth example, further comprising transmitting the reference information to the UE.
In a sixteenth example, the method of the fifteenth example, wherein the reference information is transmitted before or during SSB-less CA configuration.
In a seventeenth example, the method of the fourteenth example, further comprising determining the reference information based on a predefined rule.
In an eighteenth example, the method of the seventeenth example, wherein the predefined rule comprises determining the reference information based on (i) a Primary CC (PCC), (ii) a band of the PCC, (iii) a Primary Secondary CC (PSCC), (iv) a band of the PSCC, (v) an activated Secondary CC (SCC) with SSB having a highest signal strength or quality among SCCs, (vi) a band of the activated SCC with SSB having the highest signal strength or quality among SCCs or (vii) an activated SCC with SSB having a frequency closest to a frequency of a target SCC.
In a nineteenth example, a processor configured to perform any of the methods of the fourteenth through eighteenth examples.
In a twentieth example, a base station comprising a transceiver configured to communicate with a user equipment (UE) and a processor communicatively coupled to the transceiver and configured to perform any of the methods of the fourteenth through eighteenth examples.
In a twenty first example, a method performed by a base station, comprising decoding, based on signals received from a user equipment (UE), reference information comprising a reference component carrier (CC), a band of a reference CC, a reference Synchronization Signal Block (SSB) frequency or a reference SSB for a SSB-less carrier aggregation (CA) operation for the UE and decoding, based on signals received from the UE, capability information comprising an indication of one or more band combinations that support the SSB-less CA operation.
In a twenty second example, a processor configured to perform the method of the twenty first example.
In a twenty third example, a base station comprising a transceiver configured to communicate with a user equipment (UE) and a processor communicatively coupled to the transceiver and configured to perform the method of the twenty first example.
In a twenty fourth example, a method performed by a base station, comprising decoding, based on signals received from a user equipment (UE), capability information comprising an indication of one or more band combinations that support a Synchronization Signal Block (SSB)-less (SSB-less) carrier aggregation (CA) operation, wherein, during the SSB-less CA operation, a first serving cell transmits a first component carrier (CC) having a SSB of a CA combination and a second serving cell transmits a second CC without SSBs of the CA combination, wherein the capability information further comprises a frequency domain (FD) separation threshold indicating a value in the FD from a CC with SSB that the UE supports the SSB-less CA operation, and determining, based on the capability information, CC combinations within the one or more band combinations that support the SSB-less CA operation.
In a twenty fifth example, the method of the twenty fourth example, wherein the capability information comprises the one or more band combinations that support SSB-less CA for a largest band or CC combination set.
In a twenty sixth example, a processor configured to perform any of the methods of the twenty fourth through twenty fifth examples.
In a twenty seventh example, a base station comprising a transceiver configured to communicate with a user equipment (UE) and a processor communicatively coupled to the transceiver and configured to perform any of the methods of the twenty fourth through twenty fifth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
determine one or more band combinations that support a SSB-less carrier aggregation (CA) operation, wherein, for the SSB-less carrier aggregation (CA) operation, the apparatus is configured to process signals from a first component carrier (CC) having a Synchronization Signal Block (SSB) of a CA combination from a first serving cell and receive a second CC without SSBs of the CA combination a second serving cell; and
generate, for transmission to a network, capability information comprising an indication of the one or more band combinations that support the SSB-less CA operation.

2. The apparatus of claim 1, wherein the one or more band combinations that support the SSB-less CA operation is determined based on reference information comprising a reference CC, a band of a reference CC, a reference SSB frequency or a reference SSB.

3. The apparatus of claim 2, wherein the processing circuitry is further configured to:
process, based on signals received from the network, the reference information.

4. The apparatus of claim 3, wherein the reference information is received from the network before or during SSB-less CA configuration.

5. The apparatus of claim 3, wherein the reference information is received via radio resource control (RRC) signaling.

6. The apparatus of claim 2, wherein the processing circuitry is further configured to:
determine the reference information; and
configure transceiver circuitry to transmit the reference information to the network.

7. The apparatus of claim 6, wherein the reference information comprises a first reference information used to determine a first band combination that supports the SSB-less CA operation and a second reference information used to determine a second band combination that supports the SSB-less CA operation, wherein the first band combination and the second band combination are different band combinations.

8. The apparatus of claim 2, wherein the processing circuitry is further configured to:
determine the reference information based on a predefined rule.

9. The apparatus of claim 8, wherein the predefined rule comprises determining the reference information based on (i) a Primary CC (PCC), (ii) a band of the PCC, (iii) a Primary Secondary CC (PSCC), (iv) a band of the PSCC, (v) an activated Secondary CC (SCC) with SSB having a highest signal strength or quality among SCCs, (vi) a band of the activated SCC with SSB having the highest signal strength or quality among SCCs or (vii) an activated SCC with SSB having a frequency closest to a frequency of a target SCC.

10. The apparatus of claim 1, wherein the capability information further comprises a frequency domain (FD) separation threshold indicating a value in the FD from a CC with SSB that supports the SSB-less CA operation.

11. The apparatus of claim 10, wherein the capability information comprises the one or more band combinations that support the SSB-less CA operation for a largest band or CC combination set.

12. An apparatus comprising processing circuitry configured to:
determine reference information comprising a reference component carrier (CC), a band of a reference CC, a reference Synchronization Signal Block (SSB) frequency or a reference SSB for a SSB-less carrier aggregation (CA) operation for a user equipment (UE); and
process, based on signals received from the UE, capability information comprising an indication of one or more band combinations that support the SSB-less CA operation.

13. The apparatus of claim 12, wherein the processing circuitry is further configured to:
generate the reference information for transmission to the UE.

14. The apparatus of claim 13, wherein the reference information is transmitted before or during SSB-less CA configuration.

15. The apparatus of claim 12, wherein the processing circuitry is further configured to:
determine the reference information based on a predefined rule.

16. The apparatus of claim 15, wherein the predefined rule comprises determining the reference information based on (i) a Primary CC (PCC), (ii) a band of the PCC, (iii) a Primary Secondary CC (PSCC), (iv) a band of the PSCC, (v) an activated Secondary CC (SCC) with SSB having a highest signal strength or quality among SCCs, (vi) a band of the activated SCC with SSB having the highest signal strength or quality among SCCs or (vii) an activated SCC with SSB having a frequency closest to a frequency of a target SCC.

17. (canceled)

18. An apparatus comprising processing circuitry configured to:
process, based on signals received from a user equipment (UE), capability information comprising an indication of one or more band combinations that support a Synchronization Signal Block (SSB)-less (SSB-less) carrier aggregation (CA) operation, wherein, during the SSB-less CA operation, a first serving cell transmits a first component carrier (CC) having a SSB of a CA combination and a second serving cell transmits a second CC without SSBs of the CA combination, wherein the capability information further comprises a frequency domain (FD) separation threshold indicating a value in the FD from a CC with SSB that the UE supports the SSB-less CA operation; and
determine, based on the capability information, CC combinations within the one or more band combinations that support the SSB-less CA operation.

19. The apparatus of claim 18, wherein the capability information comprises the one or more band combinations that support SSB-less CA for a largest band or CC combination set.
